(19) United States
(12) Patent Application Publication
(10) Pub. No.: US 2026/0304528 A1
(43) Pub. Date: Oct. 1, 2026

(54) CONNECTION PRIORITY MANAGER

(71) Applicant: CenturyLink Intellectual Property LLC, Denver, CO (US)

(72) Inventors: John R.B. Woodworth, Amissville, VA (US); Dean Ballew, Sterling, VA (US)

(73) Assignee: CenturyLink Intellectual Property LLC, Denver, CO (US)

(21) Appl. No.: 19/570,797

(22) Filed: Mar. 18, 2026

Related U.S. Application Data
(60) Provisional application No. 63/778,137, filed on Mar. 26, 2025.

(51) Int. Cl. H04W 76/18; H04W 48/16; H04W 72/56

(52) U.S. Cl. CPC H04W 76/18; H04W 48/16; H04W 72/56

(57) ABSTRACT

A system and method for providing wireless connection prioritization. A connectivity priority manager generates a connection hierarchy by assigning priorities to various wireless devices with which the host device is paired. Decisions to establish connections or to reroute data to another device may be based on the assigned priorities in the connection hierarchy. The connection hierarchy may be modified by reassigning priorities based on received user input (e.g., a selection to allow, prevent, continue or cancel/undo a connection with the other device and/or allow, prevent, continue or cancel/undo rerouting of data from the one wireless device to the other wireless device). In response to the user input, the connectivity priority manager may deprioritize a particular wireless device. In some examples, the particular wireless device may be deprioritized to a lowest priority position of the connection hierarchy to prevent an undesired reconnection with the device.

### CROSS-REFERENCE TO RELATED APPLICATIONS

This application claims the benefit of U.S. Provisional Application No. 63/778,137 filed Mar. 26, 2025, entitled “Connection Priority Manager”, which is incorporated herein by reference in its entirety.

### BACKGROUND

Wireless communication technologies, such as Bluetooth, have become common in modern electronic devices, enabling wireless communication between a wide range of devices. Many host devices may be configured to support multiple pairings with multiple wireless devices, allowing users to connect to various devices seamlessly. However, this capability can sometimes lead to confusion within the wireless communication subsystem. When multiple connections are available, the wireless communication subsystem may make prioritization decisions that may be undesired by a user of the host device.

It is with these observations in mind, among others, that aspects of the present disclosure were conceived.

### SUMMARY

The present disclosure describes a system and method for providing wireless connection prioritization. A connectivity priority manager may be included in or in communication with a wireless communication subsystem of a host device. The connectivity priority manager may generate a connection hierarchy by assigning priorities to various wireless devices with which the host device is paired. Decisions to establish connections or to reroute data to another device may be based on the assigned priorities in the connection hierarchy. The connection hierarchy may be modified by reassigning priorities based on received user input (e.g., a selection to allow, prevent, continue or cancel/undo a connection with the other device and/or allow, prevent, continue or cancel/undo rerouting of data from the one wireless device to the other wireless device). In response to the user input, the connectivity priority manager may deprioritize a particular wireless device. In some examples, the particular wireless device may be deprioritized to a lowest priority position of the connection hierarchy to prevent an undesired reconnection with the device.

One aspect of the present disclosure includes a method, comprising: connecting a host device to a first wireless device via a first wireless connection; routing audio of an activity on the host device through the first wireless connection; receiving an indication of a second wireless device; generating a connection hierarchy by assigning priorities to the first wireless device and the second wireless device; determining whether to reroute the audio to the second wireless device through a second wireless connection based on the connection hierarchy; when the second wireless device is prioritized over the first wireless device in the connection hierarchy: receiving an indication of a selection of an option to prevent routing the audio to the second wireless device; continuing to route the audio of the first activity through the first wireless connection; modifying the connection hierarchy to deprioritize the second wireless device relative to the first wireless device; and storing the modified connection hierarchy.

Another aspect of the present disclosure includes a method, comprising: connecting a host device to a first wireless device via a first wireless connection; routing audio of an activity on the host device through the first wireless connection; receiving an indication of a second wireless device; connecting to the second wireless device via a second wireless connection; generating a connection hierarchy by assigning priorities to the first wireless device and the second wireless device; when the second wireless device is prioritized over the first wireless device in the connection hierarchy, rerouting the audio to the second wireless device through the second wireless connection; receiving an indication of a selection to undo the rerouting of the audio to the second wireless device; rerouting the audio to the first wireless device through the first wireless connection; and modifying the connection hierarchy to deprioritize the second wireless device in relation to the first wireless device.

Another aspect of the present disclosure includes a system, comprising: at least one processing unit; and memory storing instructions that, when executed by the at least one processing unit, cause the system to perform operations comprising: connecting a host device to a first wireless device via a first wireless connection; routing audio of an activity on the host device through the first wireless connection; receiving an indication of a second wireless device; generating a connection hierarchy by assigning priorities to the first wireless device and the second wireless device; determining whether to reroute the audio to the second wireless device through a second wireless connection based on the connection hierarchy; when the second wireless device is prioritized over the first wireless device in the connection hierarchy: presenting a first option to prevent routing the audio to the second wireless device; receiving an indication of a selection of the first option; continuing to route the audio of the first activity through the first wireless connection; and modifying the connection hierarchy to deprioritize the second wireless device in relation to the first wireless device.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following figures.

FIG. 1 is a diagram of an example system that may be implemented for providing wireless connection prioritization.

FIG. 2 is a diagram depicting examples of user inputs that may be used to modify a connection hierarchy.

FIG. 3 is a diagram depicting another example of a user input that may be used to modify a connection hierarchy.

FIG. 4 is a flowchart illustrating operations of a method for providing wireless connection prioritization according to an example.

FIG. 5 is a block diagram of a computing device with which one or more aspects of the disclosure may be implemented.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Examples may be practiced as methods, systems, or devices. Accordingly, examples may take the form of a hardware implementation, an entirely software implementation, or an implementation combining software and hardware aspects. The following detailed description is therefore not to be taken in a limiting sense, and the scope of the present disclosure is defined by the appended claims and their equivalents.

A host device may be configured to support multiple pairings with multiple wireless devices; however, a prioritization decision made by the wireless communication subsystem of the host device may cause data to be rerouted, which may be undesired by a user. Thus, aspects of the present disclosure include a system and method for providing wireless connection prioritization. A connectivity priority manager is included in or in communication with a wireless communication subsystem (e.g., a wireless protocol stack, such as a Bluetooth stack) that generates a connection hierarchy by assigning priorities to various wireless devices with which the host device is paired. In examples, a decision to establish a connection or to reroute data to another device may be based on the priorities assigned devices in the connection hierarchy. In further examples, the connectivity priority manager modifies the connection hierarchy by reassigning priorities based on user input. For instance, the user input may correspond to a selection to allow, prevent, continue or cancel/undo a connection with the other device and/or allow, prevent, continue or cancel/undo rerouting of data from the one wireless device to the other wireless device. In response to the user input, the connectivity priority manager may deprioritize a particular wireless device. In some examples, the particular wireless device may be deprioritized to a lowest priority position of the connection hierarchy to prevent an undesired reconnection with the device.

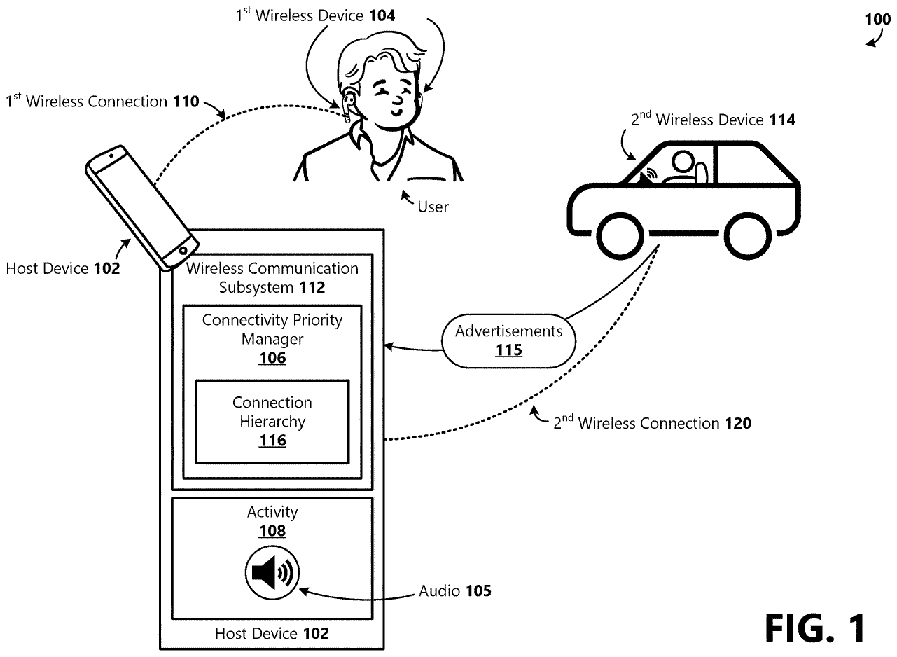

FIG. 1 depicts an example system 100 that may be implemented for providing wireless connection prioritization. In examples, the system 100 includes a host device 102 implemented as one of various types of devices, such as a mobile phone, a tablet or laptop computing device, a smart television, or other type of device that executes or performs an activity 108 that includes audio 105. For instance, the host device 102 may execute an activity 108, such as participating in a phone call, video or music playback, playing a video game, or participating in another type of activity that may include outputting and/or receiving audio 105 from one or various sources (e.g., a media file, a streaming service, a live broadcast, or a microphone).

According to an aspect, the host device 102 includes a wireless communication subsystem 112 that manages device discovery, pairing, connection, and communication with a wireless device (e.g., a first wireless device 104 or a second wireless device 114) using a wireless technology protocol such as Bluetooth, another suitable radio frequency (RF) technology, or other wireless technologies, such as light-based communications (e.g., optical wireless communication, infrared, etc.). Wireless devices may be implemented as various types of devices capable of receiving, transmitting, or both receiving and transmitting audio 105 wirelessly from/to the host device 102 when connected. Examples of wireless devices include one or more speakers, headphones, a headset, earbuds, a vehicle audio system, or other wireless-enabled audio output or input devices. In non-exclusive examples, the host device 102 includes a wireless communication subsystem 112 that uses the Bluetooth protocol for hardware communication and profiles that enable specific functionalities, such as audio streaming, hands-free calling, file transfer, etc. Bluetooth profiles may define features and data formats supported by the wireless device that the host device 102 can use to determine how audio data is transmitted, received, or controlled. Some example types of Bluetooth profiles include an advanced audio distribution profile (A2DP) that may be used to enable streaming of high-quality stereo audio, a headset profile (HSP) that may be used for basic telephony functionality, a hands-free profile (HFP) that may be used to facilitate voice communications and features, a human interface device profile (HID) that may be used for communicating user inputs to the host device 102, etc. Other types of profiles may be implemented.

In examples, the host device 102 may be paired to at least two wireless devices (e.g., a first wireless device 104 and a second wireless device 114) and connected to at least one of the two wireless devices. In the example depicted in FIG. 1, the first wireless device 104 is shown as earbuds and the second wireless device 114 is shown as a vehicle audio system. In other examples, other types of wireless devices may be implemented. In yet other examples, the host device 102 may be connected to an integrated (e.g., local) audio device and also connected to a wireless device (e.g., the second wireless device 114). During pairing with a wireless device, information about the device may be stored by the wireless communication subsystem 112 of the host device 102. The information may include the wireless device's unique identifier, a device name, services and profiles supported by the device, a class of device (CoD) classification and its capabilities, connection parameters, etc. For instance, the stored information may be used to recognize and connect to the paired wireless device in the future. In examples, the host device 102 may receive advertisements 115 from the first wireless device 104. The wireless communication subsystem 112 may recognize the first wireless device 104 based on the saved information and make a decision regarding whether to establish a first wireless connection 110 with the first wireless device 104. In further examples, the user of the host device 102 may use the host device 102 to perform a task or activity 108 that includes audio 105, and the host device 102 may route the activity audio 105 to the first wireless device 104 via the first wireless connection 110. In yet further examples, the host device 102 may receive advertisements 115 from the second wireless device 114. The wireless communication subsystem 112 may recognize the second wireless device 114 based on the saved information and make a decision regarding whether to establish a second wireless connection 120 with the second wireless device 114. In still yet further examples, the wireless communication subsystem 112 may make a decision regarding whether to reroute the audio 105 of the activity 108 from the first wireless device 104 (or the local audio device) to the second wireless device 114. According to an aspect, the wireless communication subsystem 112 may make the decisions based on a connection hierarchy 116 determined by a connectivity priority manager 106 included in or in communication with the wireless communication subsystem 112.

In examples, the connectivity priority manager 106 is configured to create the connection hierarchy 116 based on priorities assigned to different wireless devices. The connection hierarchy 116 may be used to determine which devices should be connected and/or given preference to handle audio data 105 for an activity 108. In some examples, the connection hierarchy includes a list of connected wireless devices organized by priority. In some implementations, priorities may be assigned based on a priority score calculated using one or a combination of factors, where each factor may have an assigned weight. For instance, the wireless communication subsystem 112 may use the connection hierarchy 116 to manage concurrent connections (e.g., the first wireless connection 110 with the first wireless device 104 and the second wireless connection 120 with the second wireless device 114), make connection decisions, and/or make decisions regarding whether to redirect audio 105 from one wireless device to another based on their assigned priorities. Priorities may be assigned based on various factors, such as device type, signal strength, battery level, profile type with respect to an activity 108 being performed, connection history, user preferences, etc. As an example of assigning priority based on profile type, if a user of the host device 102 is engaged in a phone call (activity 108), a wireless device that supports the HFP may be prioritized. In some examples, if multiple devices support the HFP, a particular device type may be prioritized over another device type, such as a car audio system over headphones (e.g., based on driving safety considerations (hands-free driving)).

According to an example implementation, the connectivity priority manager 106 may modify the connection hierarchy 116 based on a received user input. For instance, modifying the connection hierarchy 116 may include modifying the weight assigned to one or more factors. Modifying the weight of a factor may increase or decrease the priority score for a wireless device. In some cases, increasing or decreasing a wireless device's priority score may cause the device to be assigned a higher or lower priority in relation to another device in the connection hierarchy 116. In other cases, increasing or decreasing a wireless device's priority score may not affect the device's priority in position in relation to another wireless device. The modified connection hierarchy 116 may then be used by the wireless communication subsystem 112 for making future connectivity decisions. In some examples, a user input may be received to prevent a connection with or a transfer of audio 150 to a particular wireless device, which may cause the particular wireless device to be deprioritized in the connection hierarchy 116. In further examples, the particular wireless device may be deprioritized to a bottom position in the connection hierarchy 116. Accordingly, the connectivity decisions may be based on user indicated preferences and may provide an improved user experience.

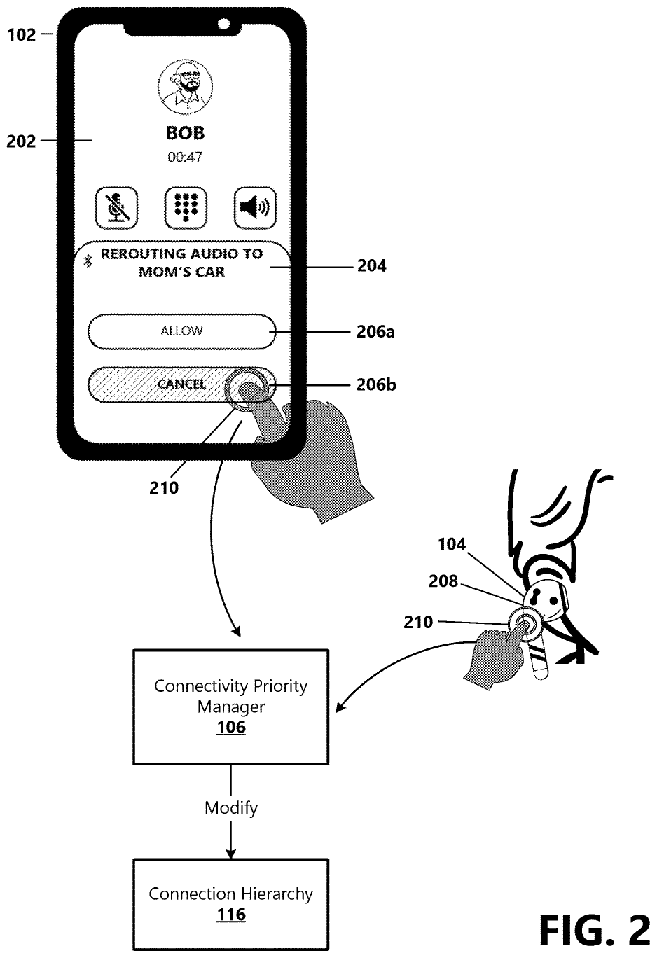

FIG. 2 depicts examples of receiving user input 210 and modifying the connection hierarchy 116 based on the user input 210. In some examples, the user input 210 corresponds to a selection made by a user of the host device 102 via a user interface 202 of the host device 102 or a user interface 208 of a first wireless device 104 with which the host device 102 is connected by a first wireless connection 110. The user interface 202 of the host device 102 and/or the user interface 208 of the first wireless device 104 may be configured to receive touch input, spoken input, a gesture, or other user input that corresponds to a desired option. In some examples, various options 206a and 206b (collectively, options 206) may be presented to the user (e.g., displayed in the user interface 202, announced, or the like) that may allow or prevent connecting to a second wireless device 114 via a second wireless connection 120. In other examples, one or more selectable options 206 may be presented to continue or cancel/undo an already established second wireless connection 120 with the second wireless device 114, or to allow, prevent, cancel/undo, or continue rerouting of activity audio 105 from the first wireless device 104 to the second wireless device 114. For instance, the user may select a button presented on a screen of the host device 102 or tap a designated area on the second wireless device 114 a specific number of times or in a specific pattern that corresponds to a selection to allow, prevent, continue or cancel/undo the second wireless connection 120 and/or allow, prevent, continue or cancel/undo rerouting of activity audio 105 from the first wireless device 104 to the second wireless device 114. In some examples, an indication of the second wireless connection 120 and/or the rerouting of the activity audio 105 is provided, such as an audible signal, a message 204 presented on a graphical user interface, a vibration, etc.

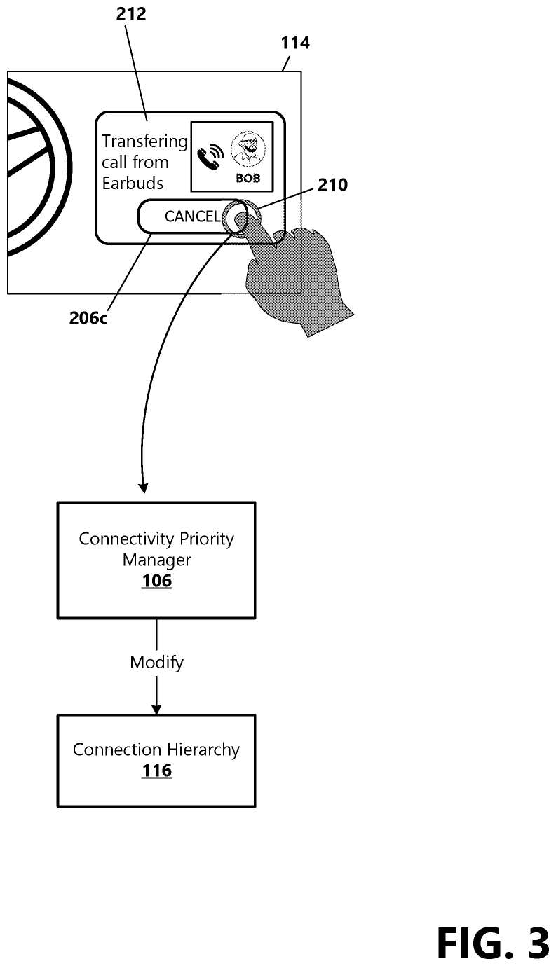

In other examples, and as depicted in FIG. 3, the user input 210 may correspond to a selection made by a user of the second wireless device 114 via a user interface 212 of the second wireless device 114. The user of the second wireless device 114 may be the user of the host device 102 (and the first wireless device 104) or a different user. The user input 210 via the second wireless device 114 may correspond to a selection of an option 206c to allow or prevent connecting to the host device 102, to continue or cancel an already established second wireless connection 120 with the host device 102, or to allow, prevent, continue, or cancel rerouting of activity audio 105 from the first wireless device 104. In some examples, the user input 210 may correspond to not receiving a selection of an option 206. For instance, the user may not select to prevent or cancel the second wireless connection 120 and/or to prevent or cancel rerouting of activity audio 105 from the first wireless device 104 to the second wireless device 114.

In examples, the connectivity priority manager 106 may receive an indication of the user input 210 and modify the connection hierarchy 116 based on the user input 210. Modifying the connection hierarchy 116 may include adjusting a weight of a factor used to calculate priority scores. For instance, an updated calculation may cause the first wireless device 104 or the second wireless device 114 to be prioritized in relation to the other device in the connection hierarchy 116. For instance, the wireless device with the higher priority (e.g., higher priority score) may be selected as the preferred device for connecting and/or routing audio 105 to in a future connection and/or rerouting decision. In some implementations, prioritizing or deprioritizing a wireless device includes making a change to how one or more factors are used or weighted to assign priority to a wireless device. For instance, less or no preference may be given to a particular profile type, device type, and/or other factor going forward.

In some examples, the connectivity priority manager 106 modifies the connection hierarchy 116 based on received user input 210 for a limited duration, such as for the duration of the first wireless connection 110 with the first wireless device 104, the duration of a current session of the activity 108, for a time period (e.g., 10 minutes, 30 minutes, 1 hour, 3 hours, 12 hours, 1 day), etc. In some implementations, the modified connection hierarchy 116 is stored by the connectivity priority manager 106 with a time-to-live (TTL) value (e.g., where a standard (unmodified) connection hierarchy 116 is also stored with no TTL value). Thus, the connection hierarchy 116 with a most-recent timestamp and which has not exceeded a TTL value may be used in determining priority. In other implementations, the connectivity priority manager 106 may modify the connection hierarchy 116 by adjusting a weight of a factor used to calculate priority scores and storing the adjusted weight with a TTL value (e.g., where the unadjusted (assigned) weight may also be stored with no TTL value). Thus, the factor weight with a most-recent timestamp and which has not exceeded a TTL may be used to calculate the priority scores. In other examples, the connection priority manager 106 may modify the connection hierarchy based on received user input 210 to always prioritize one wireless device over the other (or always deprioritize one wireless device in preference to the other). For instance, the standard connection hierarchy 116 with no TTL value may be modified or a weight assigned to a factor used to calculate the priority score may be modified without a TTL value. Options 206 provided to the user may include options to select a desired duration of the modification to the connection hierarchy 116.

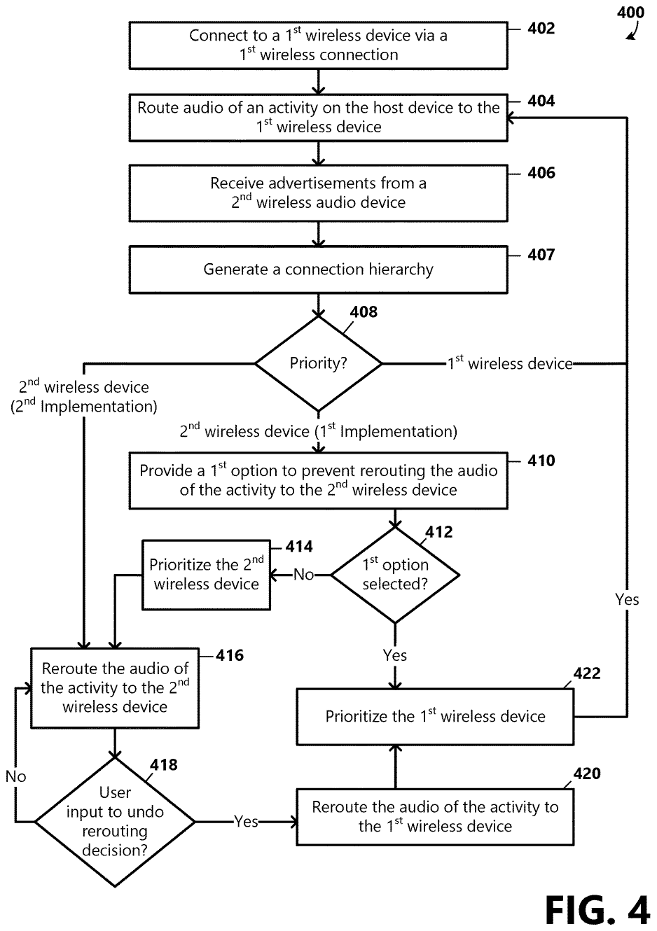

FIG. 4 depicts a method 400 for providing wireless connection prioritization according to an example. At operation 402, the host device 102 connects to a first wireless device 104 via a first wireless connection 110. For example, the first wireless connection 110 may be established using a short-range wireless communication protocol (e.g., Bluetooth or another short-range wireless communication protocol) that allows the host device 102 to wirelessly transmit and receive audio 105 to/from the first wireless device 104 (e.g., a speaker, headphones, or earbuds). In examples, the host device 102 identifies supported profiles (e.g., A2DP, HFP, HSP) of the first wireless device 104 and establishes appropriate communication channels to handle the data for the supported profiles. In examples, the host device 102 may have been previously paired to the first wireless device 104 or the first wireless connection 110 may be established after a new pairing with the first wireless device 104. Additionally, the host device 102 may be paired to at least one additional wireless device including a second wireless device 114.

At operation 404, an activity 108 may be initiated on the host device 102 that generates audio 105 (e.g., playing music, a call, watching a video). The audio 105 of the activity 108 may be routed via the first wireless connection 110 using an appropriate profile. For instance, if the activity 108 includes playing music or a video, the A2DP may be used. If the activity 108 includes making a call, the HFP or HSP may be activated. Other examples are contemplated.

At operation 406, advertisements 115 may be received from another paired wireless device (e.g., the second wireless device 114). For example, the second wireless device 114 may be turned on or may be within wireless communication range of the host device 102 and advertise its presence, such with a beaconed advertising packet. In some examples, the second wireless device 114 may be a vehicle audio system that may request the HFP from the host device 102. In further examples, the second wireless device 114 may actively request a connection with the host device 102. For instance, the second wireless device 114 may be configured to actively assert control over a particular profile (e.g., HFP) when in range, which may cause an override with another connected device. In some examples, the connectivity hierarchy 116 may be preconfigured (absent modification per the present disclosure) to prioritize a vehicle audio system over other types or classes of devices based on driving safety considerations (e.g., hands-free driving).

In response to the receiving advertisements 115, the second wireless device 114 may be recognized by the wireless communication subsystem 112 and the method 400 may proceed to operation 407, where a connection hierarchy 116 may be generated. In some examples, generating the connection hierarchy 116 includes accessing a predetermined connection hierarchy 116. For instance, a previously generated connection hierarchy may be retrieved and modified based on current conditions or used as is. In other examples, the connection hierarchy 116 may be created anew. For instance, the connectivity priority manager 106 may calculate priority scores and assign priorities to the wireless devices and generate a connection hierarchy 116 based on the assigned priorities. The connection hierarchy 116 (e.g., priority scores) may be determined based on one or a combination of factors, such as the type of activity 108 being performed, user preferences, and/or predefined settings. In some examples, the connectivity priority manager 106 may be configured to prioritize one or a combination of: a particular supported profile type (e.g., HFP), a particular wireless device, and/or a particular type or class of wireless device.

At decision operation 408, a connection decision and/or rerouting decision may be made based on the connection hierarchy 116 (e.g., a standard connection hierarchy or a temporarily instituted hierarchy). In some examples, when the first wireless device 104 is prioritized over the second wireless device 114 in the connection hierarchy 116, the second wireless connection 120 with the second wireless device 114 may not be established. In other examples, the wireless communication subsystem 112 may support multiple simultaneous connections and may establish the second wireless connection 120 with the second wireless device 114 in addition to the first wireless connection 110 with the first wireless device 104. A rerouting decision may be made at decision operation 408 regarding whether to reroute the audio 105 of the activity 108 from the first wireless device 104 to the second wireless device 114 based on the connection hierarchy 116. When the first wireless device 104 is prioritized over the second wireless device 114, the method 400 may return to operation 404, where the audio 105 of the activity 108 may continue to be routed to the first wireless device 104 via the first wireless connection 110.

Alternatively, when the second wireless device 114 is prioritized, the method 400 may proceed to operation 410 according to a first example implementation or to operation 416 according to a second example implementation. In the first example implementation, an indication that the second wireless device 114 is prioritized and/or is a preferred device to route the activity audio 105 is provided. An option 206 may additionally be provided for receiving user input 210 corresponding to a user preference to a connection and/or rerouting decision. At operation 410, a first option 206a may be provided to prevent the second wireless connection 120 and/or rerouting of the audio 105 to the second wireless device 114. In some examples, a visual and/or audible indication of the first option 206a may be presented to the user. For instance, an audible indicator may be played by the first wireless device 104 and/or a message, button, and/or other graphical user element may be displayed by the host device 102.

In examples, the first option 206a may be selected or otherwise triggered by a user input 210, such as a touch response, a verbal response, a gesture, or other input supported by the first wireless device 104. For instance, the user may tap a designated area on the second wireless device 114 a specific number of times or in a specific pattern that corresponds to a selection or trigger of the first option 206a. As another example, a spoken command from the user may be received that corresponds to the selection or trigger of the first option 206a. In some examples, the user input 210 includes a selection of a duration to prevent the second wireless connection 120 and/or rerouting of the audio 105 to the second wireless device 114.

At decision operation 412, a determination may be made as to whether the first option 206a has been selected (e.g., within a time threshold of presenting the indication of the first option 206a). In some examples, the first option 206a may be selected or triggered when a particular user input 210, such as a touch response, a verbal response, a gesture, or other input is received. When an indication of a selection of the first option 206a is not received at decision operation 412 (e.g., within the time threshold of presenting the indication of the first option 206a) the method 400 may proceed to operation 414. At operation 414, the second wireless device 114 may be prioritized over the first wireless device 114. In other example implementations, the first option 206a may include an option to allow the audio 105 to be rerouted to the second wireless device 114, which when selected, may cause the second wireless device 114 to be prioritized over the first wireless device 114 at operation 414.

The method 400 may continue to operation 416 from operation 414 or from decision operation 408 when the second wireless device 114 is prioritized (e.g., according to the second example implementation). At operation 416, the second wireless connection 120 with the second wireless device 114 may be established and the audio 105 of the activity 108 may be rerouted from the first wireless device 104 to the second wireless device 114. For instance, in the second example implementation, the audio 105 may be automatically rerouted to the device with the higher priority. In some examples, the second wireless connection 120 is established using the same profile used to route the audio 105 of the activity 108 via the first wireless connection 110. In other examples, a different profile is used. In an example scenario, when the second wireless device 114 is implemented as a vehicle audio system, the audio 105 of the activity 108 may rerouted to the vehicle audio system, where a user in the vehicle may be included in the activity 108 and the user of the host device 102 and the first wireless device 114 may be excluded from the activity 108.

At decision operation 418, a determination may be made as to whether a user input 210 to undo the rerouting decision has been received. In some examples, a second option 206b may be provided to cancel the rerouting of the audio 105 of the activity 108 to the second wireless device 114. In further examples, a visual and/or audible indication of the second option 206b may be presented to the user. Additional options 206 may be provided, such as an option to prioritize the first wireless device 114, an option to prioritize the first wireless device 114 for a particular duration or always, during the activity 108, etc. In examples, the second option 206b may be selected or otherwise triggered by a particular user input 210, such as a touch response, a verbal response, a gesture, or other supported user input type.

When an indication of a selection to undo the rerouting decision is not received at decision operation 418 (or when an indication to affirmatively allow the reroute is received), the method 400 may return to operation 416, where the audio 105 of the activity 108 may continue to be routed to the second wireless device 114 via the second wireless connection 120. Alternatively, when an indication of a selection to undo the rerouting decision is received, the method 400 may proceed to operation 420, where the audio 105 may be rerouted back to the first wireless device 104 via the first wireless audio connection 110.

At operation 422, the connection hierarchy 116 may be modified to prioritize the first wireless device 104 and/or deprioritize the second wireless device 114 in relation to the first wireless device 104 based on the user input 210. For instance, by undoing the reroute of audio 105, the second wireless device 114 may be moved to a position in the connection hierarchy 116 below the first wireless device 104. In some examples, the second wireless device 104 may be deprioritized to a bottom position of the connection hierarchy 116. In further examples, one or more factors used to prioritize a wireless device may be modified, for instance, to deprioritize a particular device type and/or profile type. In some examples, the connection hierarchy 116 may be modified by adjusting a weight assigned to one or more factors used to calculate a priority score, where the priority score corresponds to the device's position or priority in the connection hierarchy. For instance, modifying the weight of a factor may increase the priority score for the first wireless device 104 and/or decrease the priority score for the second wireless device 114. In some cases, increasing the first wireless device's priority score and/or decreasing the second wireless device's priority score may cause the first wireless device 104 to be assigned a higher priority in relation to the second wireless device 114.

The method 400 may return to operation 404, where the audio 105 of the activity 108 may continue to be routed to the first wireless device 104 via the first wireless connection 110. If a subsequent advertisement 115 is received from the second wireless device 114 or another wireless device at operation 406, the host device 102 may make a prioritization determination at decision operation 408 based on the modification made to the connection hierarchy 116.

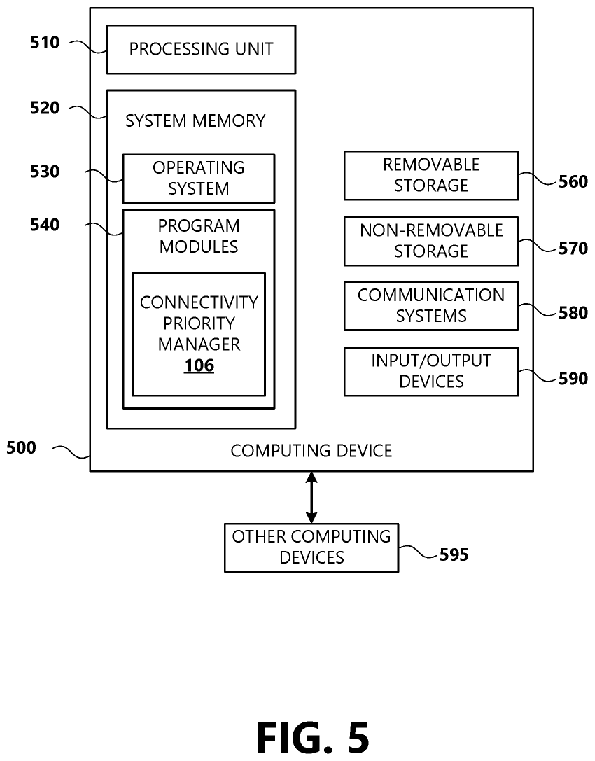

FIG. 5 is a system diagram of a computing device 500 according to an example. The computing device 500, or various components and systems of the computing device 500, may be integrated or associated with one or more components of system 100. As shown in FIG. 5, the physical components (e.g., hardware) of the computing device 500 are illustrated and these physical components may be used to practice the various aspects of the present disclosure.

The computing device 500 may include at least one processing unit 510 and a system memory 520. The system memory 520 may include, but is not limited to, volatile storage (e.g., random access memory), non-volatile storage (e.g., read-only memory), flash memory, or any combination of such memories. The system memory 520 may also include an operating system 530 that controls the operation of the computing device 500 and one or more program modules 540. The program modules 540 may be responsible for performing one more of the operations of the method 400 described above for providing wireless connection prioritization. A number of different program modules and data files may be stored in the system memory 520. While executing on the processing unit 510, the program modules 540 may perform the various processes described above. One example program module 540 includes the connectivity priority manager 106.

The computing device 500 may also have additional features or functionality. For example, the computing device 500 may include additional data storage devices (e.g., removable and/or non-removable storage devices) such as, for example, magnetic disks, optical disks, or tape. These additional storage devices are labeled as a removable storage 560 and a non-removable storage 570.

Examples of the disclosure may also be practiced in an electrical circuit comprising discrete electronic elements, packaged or integrated electronic chips containing logic gates, a circuit utilizing a microprocessor, or on a single chip containing electronic elements or microprocessors. For example, examples of the disclosure may be practiced via a system-on-a-chip (SOC) where each or many of the components illustrated in FIG. 5 may be integrated onto a single integrated circuit. Such a SOC device may include one or more processing units, graphics units, communications units, system virtualization units and various application functionality all of which are integrated (or “burned”) onto the chip substrate as a single integrated circuit.

When operating via a SOC, the functionality, described herein, may be operated via application-specific logic integrated with other components of the computing device 500 on the single integrated circuit (chip). The disclosure may also be practiced using other technologies capable of performing logical operations such as, for example, AND, OR, and NOT, including but not limited to mechanical, optical, fluidic, and quantum technologies.

The computing device 500 may include one or more communication systems 580 that enable the computing device 500 to communicate with other computing devices 595 such as, for example, routing engines, gateways, signings systems and the like. Examples of communication systems 580 include, but are not limited to, wireless communications, wired communications, cellular communications, radio frequency (RF) transmitter, receiver, and/or transceiver circuitry, a Controller Area Network (CAN) bus, a universal serial bus (USB), parallel, serial ports, etc.

The computing device 500 may also have one or more input devices and/or one or more output devices shown as input/output devices 590. These input/output devices 590 may include a keyboard, a sound or voice input device, haptic devices, a touch, force and/or swipe input device, a display, speakers, etc. The aforementioned devices are examples and others may be used.

The term computer-readable media as used herein may include computer storage media. Computer storage media may include volatile and nonvolatile, removable and non-removable media implemented in any method or technology for storage of information, such as computer readable instructions, data structures, or program modules.

The system memory 520, the removable storage 560, and the non-removable storage 570 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 500. Any such computer storage media may be part of the computing device 500. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively rearranged, included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

1. A method, comprising:
connecting a host device to a first wireless device via a first wireless connection;
routing audio of an activity on the host device through the first wireless connection;
receiving an indication of a second wireless device;
generating a connection hierarchy by assigning priorities to the first wireless device and the second wireless device;
determining whether to reroute the audio to the second wireless device through a second wireless connection based on the connection hierarchy;
when the second wireless device is prioritized over the first wireless device in the connection hierarchy:
receiving an indication of a selection of an option to prevent routing the audio to the second wireless device;
continuing to route the audio of the first activity through the first wireless connection;
modifying the connection hierarchy to deprioritize the second wireless device relative to the first wireless device; and
storing the modified connection hierarchy.

2. The method of claim 1, wherein modifying the connection hierarchy comprises reassigning priorities to the first wireless device and the second wireless device.

3. The method of claim 2, wherein modifying the connection hierarchy comprises reassigning a lowest priority to the second wireless device in the connection hierarchy.

4. The method of claim 2, wherein modifying the connection hierarchy comprises modifying a weight assigned to a factor used to:
calculate a first priority score used to assign a priority to the second wireless device; and
calculate a second priority score used to reassign the priority to the second wireless device.

5. The method of claim 1, wherein modifying the connection hierarchy comprises modifying the connection hierarchy to always deprioritize the second wireless device in relation to the first wireless device.

6. The method of claim 1, wherein modifying the connection hierarchy comprises modifying the connection hierarchy to deprioritize the second wireless device in relation to the first wireless device during the activity.

7. The method of claim 1, wherein modifying the connection hierarchy comprises modifying the connection hierarchy to deprioritize the second wireless device in relation to the first wireless device for a time duration.

8. The method of claim 1, further comprising:
providing an indication that the audio will be rerouted; and
providing the option to prevent routing the audio to the second wireless device.

9. The method of claim 8, wherein providing the option to prevent routing the audio to the second wireless device comprises providing the option via one or more of:
the host device;
the first wireless device; or
the second wireless device.

10. A method, comprising:
connecting a host device to a first wireless device via a first wireless connection;
routing audio of an activity on the host device through the first wireless connection;
receiving an indication of a second wireless device;
connecting to the second wireless device via a second wireless connection;
generating a connection hierarchy by assigning priorities to the first wireless device and the second wireless device;
when the second wireless device is prioritized over the first wireless device in the connection hierarchy, rerouting the audio to the second wireless device through the second wireless connection;
receiving an indication of a selection to undo the rerouting of the audio to the second wireless device;
rerouting the audio to the first wireless device through the first wireless connection; and
modifying the connection hierarchy to deprioritize the second wireless device in relation to the first wireless device.

11. The method of claim 10, wherein modifying the connection hierarchy comprises reassigning a first priority to the first wireless device and a second priority to the second wireless device, where the second priority reassigned to the second wireless device is lower than the first priority reassigned to the first wireless device.

12. The method of claim 11, wherein reassigning the second priority comprises assigning a lowest priority level in the connection hierarchy to the second wireless device.

13. The method of claim 11, wherein modifying the connection hierarchy comprises modifying a weight assigned to a factor used to: reassign the second priority to the second wireless device.

14. The method of claim 11, wherein receiving the indication of the selection to undo the rerouting of the audio to the second wireless device comprises receiving a user input via one of:
the host device;
the first wireless device; or
the second wireless device.

15. The method of claim 11, wherein prior to receiving the indication of the selection to undo the rerouting of the audio to the second wireless device, providing an option to undo the rerouting of the audio.

16. A system, comprising:
at least one processing unit; and
memory storing instructions that, when executed by the at least one processing unit, cause the system to perform operations comprising:
connecting a host device to a first wireless device via a first wireless connection;
routing audio of an activity on the host device through the first wireless connection;
receiving an indication of a second wireless device;
generating a connection hierarchy by assigning priorities to the first wireless device and the second wireless device;
determining whether to reroute the audio to the second wireless device through a second wireless connection based on the connection hierarchy;
when the second wireless device is prioritized over the first wireless device in the connection hierarchy:
presenting a first option to prevent routing the audio to the second wireless device;
receiving an indication of a selection of the first option;
continuing to route the audio of the first activity through the first wireless connection; and
modifying the connection hierarchy to deprioritize the second wireless device in relation to the first wireless device.

17. The system of claim 16, wherein modifying the connection hierarchy comprises reassigning a lowest priority to the second wireless device in the connection hierarchy.

18. The system of claim 16, wherein modifying the connection hierarchy comprises modifying a weight assigned to a factor used to calculate a first priority score used to reassign a first priority to the first wireless device and a second priority score used to reassign a second priority to the second wireless device.

19. The system of claim 16, wherein modifying the connection hierarchy comprises modifying the connection hierarchy to one of:
always deprioritize the second wireless device in relation to the first wireless device;
deprioritize the second wireless device in relation to the first wireless device during the activity; or
deprioritize the second wireless device in relation to the first wireless device for a time duration.

20. The system of claim 16, wherein:
presenting the first option comprises providing an indication the audio is going to be rerouted to one or more of:
the host device;
the first wireless device; or
the second wireless device; and
receiving the indication of the selection of the first option comprises receiving a user input corresponding to the first option.
